(19) United States
(12) Patent Application Publication
(10) Pub. No.: US 2026/0181059 A1
(43) Pub. Date: Jun. 25, 2026

(54) METHODS, APPARATUSES AND SYSTEMS FOR DYNAMIC CONTROL OF CONFIGURATION PARAMETERS

(71) Applicant: InterDigital Patent Holdings, Inc., Wilmington, DE (US)

(72) Inventors: Faris Alfarhan, Montreal (CA); Samuli Turtinen, Ii (FI); Ghyslain Pelletier, Montreal (CA); Paul Marinier, Brossard (CA)

(21) Appl. No.: 18/990,533

(22) Filed: Dec. 20, 2024

(51) Int. Cl. H04L 69/18; H04W 28/18

(52) U.S. Cl. CPC H04L 69/18; H04W 28/18

(57) ABSTRACT

Procedures, methods, apparatuses, systems, devices, and computer program products are provided for a wireless transmit/receive unit (WTRU) to communicate with a wireless network. The WTRU stores a plurality of configuration containers, each comprising one or more configuration parameters and a container index. The WTRU receives, from a wireless network, a radio control element (RCE), wherein the RCE is transmitted by the wireless network using a data layer protocol, and comprises a configuration index associated with a configuration container and corresponding configuration information. The WTRU transmits a confirmation to acknowledge reception of the received RCE, selects a configuration container corresponding to the configuration index, and updates the one or more configuration parameters based on the configuration information.

### TECHNICAL FIELD

The present disclosure is generally directed to the fields of communications, hardware, software, and encoding, including, for example, to methods, apparatuses, and systems related dynamically controlling configuration parameters.

### BACKGROUND

The transmission of radio resource control (RRC) parameters creates considerable overhead that is scalable with the number of cells, beams, logical channels (LCHs), features, etc. Additionally, reconfiguration of a single parameter requires a reconfiguration procedure that uses messages that are large in size and the process is slow. Numerous technical challenges exist for dynamically changing RRC parameters and reducing this overhead.

### SUMMARY

In certain representative embodiments, a method is performed by a wireless transmit/receive unit (WTRU) communicating with a wireless network. Methods and WTRUs are disclosed herein for storing a plurality of configuration containers, each comprising one or more configuration parameters and a container index, and receiving, from a wireless network, a radio control element (RCE). The RCE may be transmitted by the wireless network using a data layer protocol, and comprises a configuration index associated with a configuration container and corresponding configuration information. The methods and WTRUs may transmit a confirmation to acknowledge reception of the received RCE, select a configuration container corresponding to the configuration index, and update the one or more configuration parameters based on the configuration information.

In certain representative embodiments, the data layer protocol may correspond to a layer 2 media access control (MAC) protocol. In certain representative embodiments, the configuration index is determined from an indication part of a transport block subheader or a value tag within a payload of the RCE.

In certain representative embodiments, the one or more configuration parameters comprises at least one of cell beam parameters, a number of antenna elements and associated configuration parameters, physical layer transmission parameters, or configuration parameters for data flow. In certain representative embodiments, the one or more configuration parameters comprises at least one of priority, minimum or guaranteed bit rates, MAC configuration parameters, PDCP parameters, or RLC configuration parameters.

In certain representative embodiments, the updated one or more configuration parameters are used to configure the WTRU for a limited period of time, and the limited period time is specified by at least one of the RCE or by a higher layer signaling protocol in relation to the intermediate layer protocol.

In certain representative embodiments, storing a plurality of configuration containers further comprises storing the plurality of configuration containers in the form of a tree structure comprising a plurality of nodes, and selecting the configuration container comprises selecting the node corresponding to the configuration container and one or more lower hierarchy nodes that depend from the selected node. In certain representative embodiments, updating the one or more configuration parameters based on the configuration information comprises updating the one or more configuration parameters for the configuration container corresponding to the selected node and the one or more configuration parameters for one or more configuration containers corresponding to the one or more lower hierarchy nodes.

In certain representative embodiments, the RCE comprises segmentation information indicating at least one of an identity of a first RCE segment of a plurality of RCE segments of the RCE, a total size of the plurality of RCE segments, a number of the plurality of RCE segments, or sizes of the plurality of RCE segments.

In certain representative embodiments, an acknowledgement is received from the wireless network, where such acknowledgment corresponds to successful reception of the confirmation, wherein updating the one or more configuration parameters is performed after receiving the acknowledgement.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating communications between a WTRU and a wireless network, in accordance with certain embodiments of the present disclosure;

FIG. 3 is an illustrative tree structure, in accordance with certain embodiments of the present disclosure; and

FIG. 4 is a procedural diagram illustrating an example procedure, performed by a WTRU, in accordance with certain embodiments of the present disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

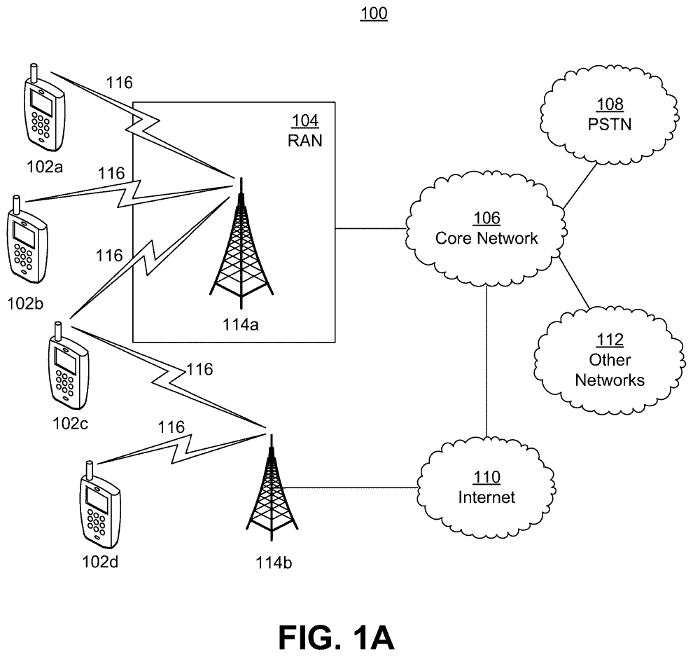

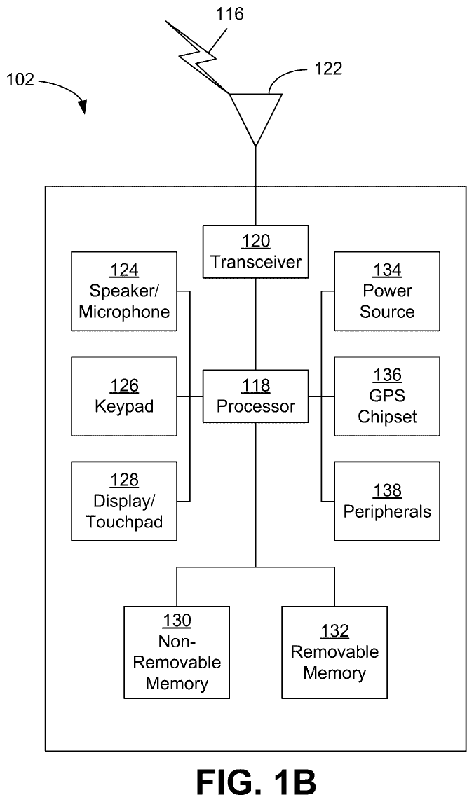

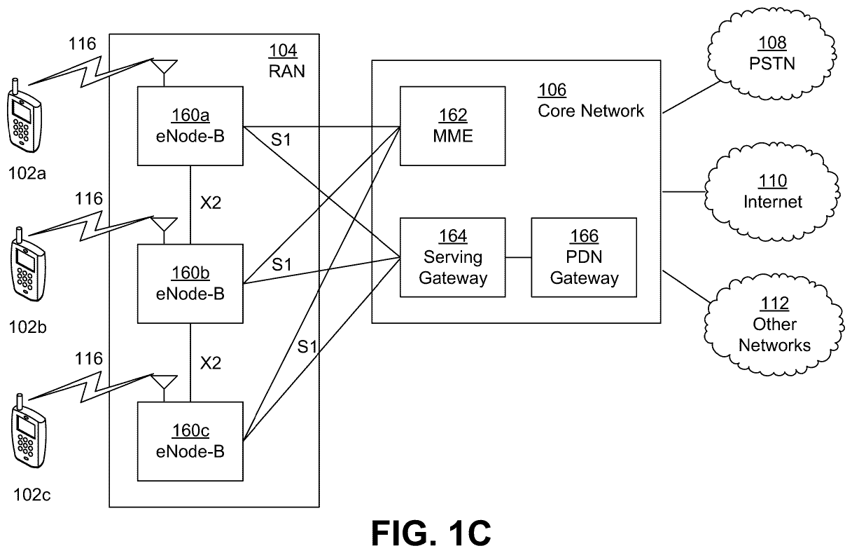

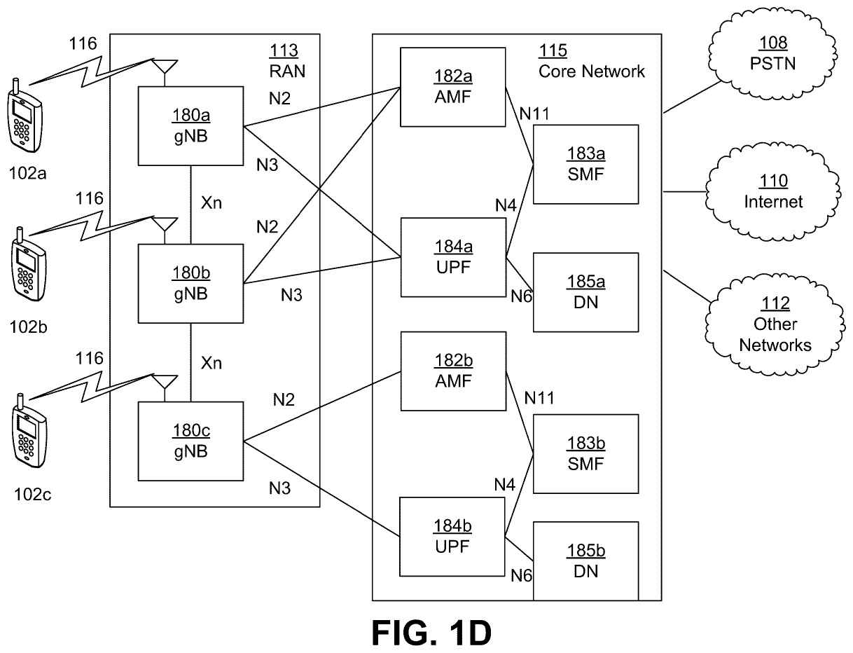

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

Radio resource control (RRC) layer and configuration: The radio resource control (RRC) sublayer function includes the broadcast of System Information (SI) pertaining to access stratum (AS) and non-access stratum (NAS). The RRC sublayer also manages the establishment, maintenance, and termination of the RRC connection between the WTRU and the network (including the radio and core parts). RRC provides a set of configuration parameters for operation of various physical layer (PHY), MAC, and higher layer functions and services.

QoS management functions configured by the RRC help ensure the prioritization of traffic as per its significance and requirement. RRC is used to configure the radio bearers with the proper parameters that is aligned with the QoS requirements of the bearers (e.g., priorities, bit rates, delay budget, and the like). The network can ensure the WTRU gets resources for the transmission of UL data and reception of DL data at RRC level via the configuration of semi-persistence scheduling resources (SPS), and configured grants (CG)s, respectively. Additionally, RRC sublayer specifies WTRU measurement reporting, controlling its frequency and consistency, channel state reporting, as well as ensuring rapid detection and recovery from any radio link failures. The RRC acts as a conduit for the transfer of NAS messages between NAS and WTRU, maintaining bidirectional communication integrity.

RRC provides configuration of the WTRU security context of the WTRU, which includes security keys and security algorithms to be used for the encryption and integrity protection of signaling radio bearers and data ratio bearers (integrity protection). RRC also ensures the robust establishment, configuration, and management of radio bearers. RRC further specifies crucial mobility functions and operations, handovers, context transfers, cell selection and reselection in IDLE mode.

In RRC connected mode, the WTRU is able to receive downlink data from the network in a unicast fashion and also send uplink data to the network. Network may configure the WTRU to send measurement reports periodically or when certain conditions are fulfilled and based on these reports may send the WTRU a handover command to move the WTRU to another cell/node. The WTRU can request other SI by sending a request to the network, in a dedicated manner, e.g., via UL-DCCH (dedicated control channel) and the granularity of the request is one SIB. The gNB may respond with an RRCReconfiguration including the requested SIB(s). It is a network choice to decide which requested SIBs are delivered in a dedicated or broadcasted manner.

An RRC message may be segmented in case the size of the encoded RRC message PDU exceeds the maximum packet data convergence protocol (PDCP) service data unit (SDU) size. Segmentation may be performed in the RRC layer using a separate RRC protocol data unit (PDU) to carry each segment. The receiver reassembles the segments to form the complete RRC message. All segments of an RRC message are transmitted before sending another RRC message. Segmentation is supported in both uplink and downlink.

Abstract Syntax Notation One (ASN.1) is a standardized notation used for describing the structure of control data carried by messages exchanged between communicating entities, typically used to exchange information across an interface or communication medium. ASN.1 has been standardized internationally. It is widely used in the specification of communication protocols. ASN.1 is a mature notation with reliability and interoperability. The ASN.1 syntax for a subject name is shown in this example:
Name ::=Sequence of RelativeDistinguishedName
RelativeDistinguishedName ::=SET OF AttributeTypeValue
AttributeTypeValue ::=SEQUENCE
{
   type OBJECT IDENTIFIER,
   value ANY
}

In such example, “AttributeTypeValue” is considered an Information Element (IE), while “type” or “value” is considered a configuration parameter of the IE. Layer 1/layer 2 (L1/L2) triggered mobility (LTM): LTM is a procedure in which a gNB receives L1 measurement reports from a WTRU, and on their basis the gNB may change WTRU serving cell by a cell switch command signaled via a MAC control element (CE). The cell switch command indicates an LTM candidate configuration that the gNB previously prepared and provided to the WTRU through RRC signaling. Then the WTRU switches to the target configuration according to the cell switch command. The LTM procedure can be used to reduce the mobility latency. The LTM procedure is one example of control an RRC Procedure and configuration by L2 signaling.

The following principles apply to LTM: security keys are maintained upon an LTM cell switch; subsequent LTM is supported. LTM supports both intra-gNB-DU (distributed unit) and inter-gNB-DU mobility within the same gNB-CU (centralized unit). The following scenarios are supported: PCell (primary cell) change in non-CA (carrier aggregation) scenario and non-DC scenario; PCell and SCell(s) (secondary cell) change in CA scenario; DC scenario.

While the WTRU has stored LTM candidate configurations the WTRU can also execute any layer 3 (L3) handover except for dual active protocol stack (DAPS) handover. In the RRC message which the WTRU applies for any L3 handover, LTM candidate configurations can be added/modified/released by the target cell.

It may be desirable to reduce RRC configuration overhead and allow for dynamic control of some RRC configuration parameters without having to send the whole IE/ASN.1 configuration, which can be both, quite large, and sensitive to long delays due to possible CU-DU architecture in the network (NW) side and long WTRU processing times. Furthermore, the overhead scales with the number of cells, beams, logical channels (LCHs), features, etc.

Overhead and semi-static nature of RRC signaling: RRC configuration creates considerable overhead that is scalable with the number of supported features by the WTRU, the number of LCHs/data flows, number of antennas at the WTRU, number of beams, e.g. synchronization signal blocks (SSBs) at a serving cell, etc. Further, many configurations are carried out using ASN.1 messages that are very large in size. Reconfiguration of a single parameter often requires an RRC reconfiguration procedure to exchange the IE, which can be expensive from an overhead perspective and also quite slow, especially when the intent is to alter a subset of configuration parameters.

Another aspect of the problem is that the RRC (re-)configurations are also “slow” for very dynamic changes, especially in NW implementations where the CU-DU split is exploited. Fronthaul interface (F1 in NR) may contribute to the delay in transmitting the RRC message to the WTRU—sometimes even more than the air interface (fronthaul delay can be up to 10ms). On the other hand, keeping RRC in the CU at the NW often helps provide flexibility in NW implementation helps control the mobility of the WTRU effectively. Hence, being able to divide the control/configuration functions between the CU and DU at the NW side could also come with the benefit of less configuration latency and more dynamic configuration changes.

One possibility is to allow some RRC configuration parameters to be controlled by messages from data layer, data link layer, or intermediate layers (e.g. MAC layer), which offers a faster timeline, an ability to shorten the configuration message, and reliability by a hybrid automatic repeat request (HARQ), without having to introduce ANS.1 style in MAC. Some RRC configuration control for radio unit (RU) aspects from DU can be moved to the MAC layer. One example that illustrates this is when the number of MIMO components scales (e.g. NW beams, including SSBs, and related reference signals, WTRU antenna elements, beam failure recover beams, number of TRPs), frequent RRC reconfiguration may be performed, increasing signaling overhead in the system. Associated challenges with this approach include how to secure MAC CEs containing configuration information; how to send variable sizes of configuration info (e.g., subsets of an IE) in a MAC or data layer, data link layer, or intermediate layer message; how to ensure that configuration messages sent over a user plane layer is delivered timely and reliably; how to ensure that the WTRU has received the MAC configuration message successfully; how a confirmation can be prioritized among other control data (e.g. signaling radio bearers or SRBs) or user plane data (e.g. data radio bearers or DRBs).

Dynamic and efficient exchange of WTRU capabilities and states: A related problem (on the uplink side): in 5G NR, there are many capability combinations in the population of WTRUs in a serving cell, and that can be very confusing for the scheduler. One possibility in 6G is to simplify categories and move towards more of a categorized WTRU capability or quantifiable ones. Further, some WTRU capabilities may therefore be changed dynamically depending on the WTRU state, time, WTRU power saving state, NW energy saving state, WTRU heating state, etc.

MAC messages (e.g. CEs) can be used to dynamically reply to a capability/WTRU state. In one example, the network asks if the WTRU can process physical downlink control channel (PDCCH)/SRS (sounding reference signal) with a given assumption, and WTRU replies yes or no (Y/N) in MAC CE or replies with its current processing/power saving/power consumption state/processing state, CPU load, heating state, or the like. Such MAC CE can thus also be used whether the WTRU has received a DL MAC CE indicating a change of configuration or configuration parameters.

A related problem (on the uplink side): dynamic uplink control messages within a L2 design can be used to indicate and/or exchange control information that is typically carried in an RRC message.

In certain representative embodiments, the present disclosure provides solutions for enabling configuration control to be transmitted by a data layer, data link layer, or intermediate layer (e.g., the MAC sublayer) instead of, or in addition to, RRC sublayer, including structuring control information into radio control elements of MAC and supporting segmentation functionality for this information at the data layer, data link layer, or intermediate layer.

In certain representative embodiments, the present disclosure provides for intermediate layer (e.g., MAC) control/alteration of configuration parameters without having to introduce ASN1 style in MAC, whereby control functions are moved to data layer, data link layer, or intermediate layer signaling without having to indicate IE configurations in the intermediate layer CE. The data layer, data link layer, or intermediate layer controls a subset of the configured IEs by RRC. An L2/L3 framework may be provided for radio resource control, MAC CE control of RRC configuration parameters, and RRC configuration overhead reduction in, e.g., 5G or 6G, in the control plane and the data plane, of 5G or 6G.

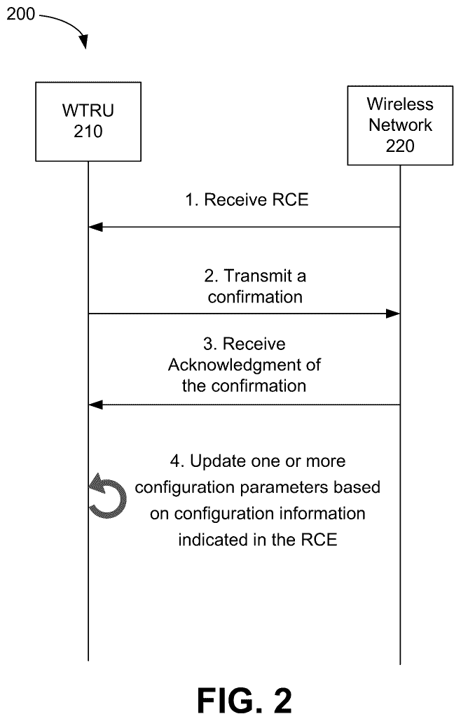

An example of signal exchange between WTRU and a wireless network is provided. For example, as shown in FIG. 2, a system 200 includes a WTRU 210 (e.g., WTRU 102 or the like) and wireless network 220 (e.g., RAN 104/113, or the like). For example, the WTRU may comprise a processor; computer memory coupled to the processor; and a transceiver coupled to the processor A method related to the system 200 includes one or more steps. For example, at step 1, the WTRU 210 receives a radio control element (RCE) from wireless network 220. Further, for example, at step 2, WTRU 210 transmits a confirmation to acknowledge reception of the received RCE to wireless network 220. Further, for example, at step 3, WTRU 210 receives an acknowledgment of the confirmation from wireless network 220. Further, for example, at step 4, WTRU 210 updates one or more configuration parameters based on configuration information indicated in the RCE.

The WTRU 210 may be configured based on the RCE, which refers to a downlink control message transmitted by data layer, data link layer, or intermediate layer protocols (e.g. MAC or another L2 layer, or an L3 layer), and such downlink control message can provide some or all of configuration or configuration parameters typically provided by semi-static signalling (e.g. RRC configuration), in some cases over multiple segments (e.g. PDUs). The RCE may be, for example, a data layer, a data link layer, or an intermediate layer RCE, such as, for example, a MAC RCE, which may be also be referred to as a radio control MAC CE.

In certain representative embodiments, the WTRU is configured based on the RCE, the downlink radio control message transmitted by a layer-2 protocol (e.g. MAC) signaling, and the WTRU may be configured semi-statically with a plurality of configuration containers, each comprising of one or more configuration parameters, one or more associated configuration values, and a container index. For each configuration container, the WTRU may be configured semi-statically with a configuration index, which may be indicated by the RCE, and associated configuration parameters then can be altered by the RCE. In certain representative embodiments, the WTRU receives the RCE indicating one or more RCE components, where each RCE component corresponds to a configuration container index and each component provides configuration information for some or all configuration parameters for the associated configuration container. Upon reception of the RCE, the WTRU transmits a confirmation to acknowledge reception of the RCE.

In certain representative embodiments, the WTRU determines the configuration container index and/or the associated configuration parameters from RCE component index. The WTRU may determine the RCE component index from an indication part of transport block subheader or a value tag within the RCE payload. Upon reception of the RCE or an acknowledgement corresponding to the UL confirmation RCE, the WTRU applies the configuration indicated in the RCE to one or more configuration parameters.

In certain representative embodiments, the present disclosure provides for RRC signaling overhead reduction, and faster application of re-configuration of configuration parameters.

The WTRU may be configured with a multitude of features, data flows, cells, carriers, bandwidth parts, TRPs, and/or cell beams, and the like, herein referred to as a configuration container (e.g. an IE in the ASN.1 context). Each configuration container may be additionally configured with associated configuration parameters that are applicable to the container. Each container may be identified by a name, a number, and/or an index.

In certain representative embodiments, a configuration container can correspond to IE configuring cell beam parameters (e.g. SSBs), an IE configuring MIMO related configuration (e.g. a number of antenna elements and associated configuration parameters, e.g. channel state information (CSI), and CSI reporting) an array of physical layer transmission parameters (e.g. power control parameters, UCI transmission types and associated configurations etc.), and the like. In another example, a configuration container may correspond to data flow (e.g. LCH) configuration parameters, and the RCE can be used to control and alter a subset of the data flow configuration parameters including: priority, min/guaranteed bit rates, MAC/PDCP/RLC (radio link control) configuration parameters pertaining to the data flow, and the like. A configuration container may correspond to a group of data flows or a group of packets (e.g. logical channel group (LCG), or a PDU set) configuration parameters, and the RCE can be used to control and alter a subset of the configuration parameters.

In certain representative embodiments, the WTRU may receive signaling indicating a subset of the configuration containers and/or configuration parameters, whereby the signaling is carried out as part of a MAC RCE or RCE. The RCE may indicate a subset of configuration containers. For each indicated configuration container, the RCE may additionally indicate a subset of configuration parameters that are (re)-configured by RCE indication, and the WTRU may then assume the configuration values that are indicated as part of the RCE rather than by semi-static configurations (e.g. RRC). For a configuration parameter that is indicated by the RCE, the WTRU may assume that the configuration parameter is altered going forward (e.g. permanently or semi-statically until altered again), for a limited period of time; the period may be configured by higher layer signaling (e.g. RRC), predefined, or indicated part of the RCE. Upon expiry of such period, the WTRU may revert to the configurated semi-static value by higher layer signaling (e.g. RRC).

For each semi-static configuration container, semi-static configuration may configure whether such container can be/is expected to be indicated by RCE signaling. For each semi-static configuration container and/or each configuration parameter within the container, semi-static configuration may configure an associated RCE indication index, number, or value. The RCE index can be composed of one or more hierarchies, where, for example, one top level hierarchy indicates the configuration container, and a lower level hierarchy indicates the configuration parameter. For example, some MIMO or PHY configurations may be configured or reconfigured, such as via CSI reporting MAC CEs, which may activate a configured config/subconfig.

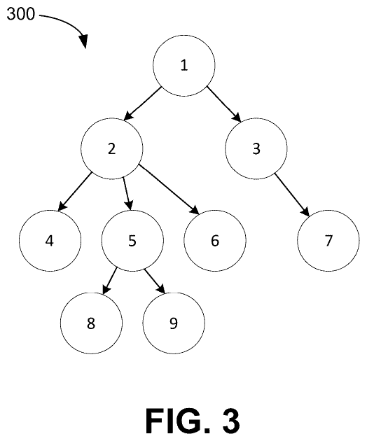

FIG. 3 shows that, in certain representative embodiments, a “configuration tree” structure 300 may be exploited for the RCE, e.g., depending on how many features/distinct parameters are configured with one RCE (e.g., a MAC RCE). In one example, a field in a subheader (e.g., a MAC subheader) of the RCE (e.g., a MAC RCE) is used to indicate a specific node in the configuration tree. For example, a logical channel ID (LCID), such as, for example, a MAC LCID, may be used for this purpose. For example, LCID #1 may point to a higher node of the tree and can be used to reconfigure various parameters, e.g., including configurations for CSI, TCIs, RS, etc., while LCID #2 may point to a specific node under the higher node, e.g., CSI configuration.

In another example, multiple fields may be exploited where the first field defines the highest node of the tree (for the configuration) and subsequent field(s) may specify certain lower node(s) of the tree defining the specific feature/configuration IE to be configured by the RCE (e.g., a MAC RCE).

In one example, different processing times may be specified depending on how high and/or deep in the tree the RCE (e.g., a MAC RCE) configures the WTRU.

In one example, the highest tree node points to the full configuration message where the MAC RCE may configure all the configurations possible for the MAC RCE. In another example, multiple “trees” are defined and the highest node of each tree points to the block of configuration parameters—e.g., PHY configuration and MAC configuration is provided over different trees.

In one example, RRC configures the mapping between the tree nodes and the index values indicated in the subheader (e.g., a MAC subheader). In an alternative example, the mapping between the subheader (e.g., a MAC subheader) field index values and the tree nodes (e.g., configuration message/IE) is pre-defined (e.g., in specification).

In one example, the WTRU may determine the depth of the configuration tree that is indicated part of the RCE as a function of the LCID value. For example, in the example of FIG. 3, an indication of value 1 in the RCE header may implicate that all configuration parameters for configuration containers corresponding to nodes under the tree 1 (e.g., including nodes 2-9) are altered or indicated. As another example, an indication of value 5 in the RCE header may implicate that configuration parameters for configuration containers corresponding to nodes 5, 8, and 9 shown in FIG. 3 are altered or indicated, and so on, e.g., since nodes 8 and 9 depend from node 5.

In one example, one LCID field can be used to indicate a configuration container index (higher hierarchy), and another LCID/header field can be used to indicate a configuration parameter index (lower hierarchy) within the container.

In one example, the RCE header may contain an extension field or bit, to indicate whether dependent configurations of the indicated tree value are present/indicated in the RCE.

In one example, a first RCE (e.g., a first MAC RCE) may contain (or otherwise indicate or reference) a configuration tree structure of a second RCE (e.g., a second MAC RCE).

In the example of FIG. 3, tree structure 300 of FIG. 3 for the RCE (e.g., a MAC RCE) is defined where the highest node of the tree (“1”) may indicate to “BWP (bandwidth part) configuration” and the two sub-nodes (“2” and “3”) to DL and UL BWP configuration, respectively. Furthermore, the deeper into the tree, the more specific configurations are possible, e.g., PDCCH-config by node “5” and search space related configurations by node “6”.

In certain representative embodiments, regarding the impact of NW architecture on radio RCEs (e.g., radio control MAC CEs), when a fronthaul interface is exploited in the NW (e.g., CU-DU split architecture) where RRC and MAC are separated, NW coordination between the CU and DU is used (in at least for some cases) to enable and operate with both RRC and RCE (e.g., MAC) RCE)-based control.

In one example, the RRC messages transmitted to the WTRU are encrypted at the CU (e.g., by PDCP layer or similar) and the configuration is provided to DU in a separate container through the fronthaul interface. Furthermore, in this case, the MAC RCEs may be encrypted at the DU (e.g., by the MAC layer itself) upon generating them or upon transmission. In one example, the MAC control part of the MAC PDU is ciphered by the MAC layer.

In another example, the MAC layer encryption is applied for both the RRC messages and RCEs (e.g., MAC RCEs). For example, the MAC layer may only encrypt control information while another user plane (UP) layer (e.g., PDCP or similar) may encrypt UP data.

In one example, the RCE (e.g., MAC RCE(s)) may only configure/change RRC configured parameter values and/or sets of used parameters and their values. In this case, in an example, DU to CU signaling about all the reconfigurations (if any) may not be employed. In an example, each set of parameters is given an index which is signaled in the RCE (e.g., the MAC RCE)—this way, no MAC security may be employed for MAC RCE based on reconfigurations.

In another example, the RCE (e.g., MAC RCE(s)) may also include configurations of new parameters/parameter sets. In this case, in an example, DU signals to CU the new configuration. The signaling may be done before, on, or after configuring the WTRU.

In another example, both of the above configurations are possible for the RCE (e.g., MAC RCE) and it is pre-defined (e.g., by the specification) which parameters/parameter sets may be configured by the RCE (e.g., MAC RCE) and for which parameters only the values or set of parameters may be configured/changed by the RCE (e.g., MAC RCE). In one alternative option, the RRC configures what may be configured by the RCE (e.g., MAC RCE).

In yet another example, the MAC RCE may invoke a full RRC configuration, e.g., by means of a configuration index provided to the WTRU over RRC configuration beforehand.

In certain representative embodiments, regarding timing and processing aspects of RCEs, generally, RCE (e.g., MAC RCE) based configurations processing times at the WTRU should be shorter to be able to exploit them and bring benefits. Hence, a WTRU capability dependent or RCE (e.g., MAC RCE) dependent processing times may be specified.

In one example, the RCE (e.g., MAC RCE) processing time is based on the content/configuration provided by the RCE (e.g., MAC RCE). For example, each RCE (e.g., MAC RCE) is specified a specific processing time that is supported by a WTRU.

In another example, the RCE (e.g., MAC RCE) processing time is further/alternatively based on WTRU capability indicated to the NW (based on which the NW knows the processing time required by the WTRU). For example, a lower category WTRU (e.g., RedCap in NR) might take 15 ms to process a certain RCE (e.g., MAC RCE) but a higher category WTRU might perform equal reconfiguration processing within 4 ms.

In another example, both the RCE (e.g., MAC RCE) and WTRU capability-based processing times are defined.

The WTRU may apply configuration values indicated as part of the RCE after successful reception of the PDU containing the RCE (e.g. as a function of a cyclic redundancy check (CRC) check success), after transmitting the uplink confirmation RCE (e.g., MAC CE), after receiving an acknowledgement corresponding to successful reception of the uplink confirmation RCE (e.g., MAC CE) that is transmitted by the WTRU in response to reception of a DL RCE, and/or after a period has elapsed from the physical data shared channel (PDSCH) or ACK reception.

In certain representative embodiments, the RCE (e.g., radio control MAC CE) containing configuration information (e.g., similar to ASN.1 or encoded using ASN.1) could be larger than a transport block (TB) size, so a segmentation mechanism may be provided, and/or various RCE (e.g., MAC CE) formats may be provided, and/or the RCE (e.g., MAC CE) design that allows a variable size/indication of remaining configurations in another RCE (e.g., MAC CE) may be provided.

In one example, the RCE can be a DL MAC CE, configured based on one or more formats (e.g. a range of LCIDs). The WTRU may be predefined and/or configured with a plurality of formats for the RCE (e.g., a MAC RCE), including a short, fixed size format, a long-fixed size format, a variable size format, predefined size or a size configured by semi-static signaling, a truncated RCE (e.g., MAC RCE), and the like.

Regarding the short, fixed size format, the size of the MAC RCE may be fixed and the number of fields/octets may be predefined. For example, a short format can include an indication for a configuration container, an indication of a configuration parameter within the container, and an associated value to apply for the configuration. The size of the value field can be fixed and predefined (e.g. one or two octets). This is referred to as the RCE component herein.

Regarding the long-fixed size format, a collection of RCE components, e.g. a number of “short fixed size format” control elements may be employed, where the collections number is predetermined in specifications.

Regarding the variable size format, a collection of RCE components, e.g. a number of “short fixed size format” control elements may be employed, where the collections number is indicated dynamically part of the RCE (e.g. in a MAC CE header, or determined from the indicated LCID, or a part thereof). In one example, the RCE (e.g., MAC RCE) header may indicate the number of RCE components, the number of octets, and/or number of configuration containers. In one example, at the end of each RCE component, an extension bit can be present to indicate whether an additional RCE component is included (e.g. 0 indicates no more RCE components present in the MAC CE, 1 indicates at least one more RCE component is present in the MAC CE); whether an additional configuration parameter within the RCE component is indicated (e.g. 0 indicates no more configuration parameters within the RCE component is present in the MAC CE, 1 indicates at least one more configuration parameter within the RCE component is present in the MAC CE); or whether an increased size for the configuration value field is to be used (e.g. 0 indicates a value size of 1 octet, 1 indicates a values size of 2 octets).

For each indicated configuration container, the WTRU may determine an applicable associated size for the configuration parameters, an associated number of configuration parameters within the RCE component/configuration container, and/or the configuration value field size. The associated size for each of these can be predefined or configured by semi-static signaling. The WTRU may determine any of these as a function of the RCE component (e.g. the configuration container index) that is indicated and/or from the header of the MAC RCE (e.g. the LCID value).

Regarding the truncated RCE (e.g., MAC RCE), the WTRU may determine that the RCE contains a non-fractional number of RCE components. For example, the RCE may contain x out of y octets needed to indicate a given RCE component, where the value of x is indicated as part of the RCE (e.g., MAC RCE) or its header. The WTRU may assume the remaining part of the RCE component (e.g. the y-x octets) will be received in another RCE (e.g., MAC RCE).

A header (e.g., a MAC header) and/or LCID may indicate which of the above formats is expected for the RCE (e.g., MAC RCE). The location of the RCE (e.g., MAC RCE) within a DL TB can be predefined, e.g. after or before MAC headers, at the beginning of the PDU before other user plane data, at the end of the PDU after user plane data. Such determination of the location of the RCE (e.g., MAC RCE) may be made as a function of the header (e.g., a MAC header), or as a function of the header fields used to indicate the RCE type, or from a physical layer property of the PDSCH (e.g. a scrambling or CRC used), or from a property of the PDCCH used to schedule the TB containing the RCE (e.g., MAC RCE).

The WTRU may assume that RCEs preside within a self-decodable and/or separate part of a TB. For example, MAC RCEs may be located within a reserved/spare part in the DL assignment/grant for inclusion of MAC CEs and/or the RCE. Such spare part can be a separately decodable TB portion within the TB, where such parts are encoded/decoded separately (e.g. may have separate CRCs and/or MAC headers).

In certain representative embodiments, the RCE can be a control PDU within an data layer, data link layer, or intermediate L2 layer (e.g. a PDCP control PDU, RLC control PDU, or an SDAP/QoS layer control PDU). The format structure may follow a similar design of the MAC RCE formats but is rather contained a control PDU coming from layers above MAC.

In certain representative embodiments, the RCE can be determined as function of a QoS marker provided by a UP layer, an internet layer, or the core network. The WTRU may determine an applicable configuration value is changed as a function of the QoS marker, where there may be a semi-static configuration associating the RCE, a configuration parameter/container, and/or an association configuration parameter value with a QoS marker. The WTRU may determine the RCE from a QoS marking associated with a data flow or a QoS marking associated with a given packet. In such case, the RCE and/or the applicable configuration parameter/value may be applicable for a given packet for which the marking is applied, applied for a given flow (e.g. whereby the RCE is applied as a start change of configuration as a function of “start” marker), or the WTRU stops applying the configured parameter/value once a stop marker is received or once a second QoS marker is received.

In certain representative embodiments, the RCE can be generated by RRC layer of the WTRU and transmitted through the RCE (e.g., MAC RCE) container. For example, in this case, the MAC layer performs encryption of the RCE and network can decode the RCE at the MAC layer (or by another layer, e.g., the lower RRC) but still within the DU of the NW (if such implementation is applied). In this case, in an example, the RRC ASN.1 structure can be applied for the RCE and the MAC LCID (or any other field) may be used to indicate to a certain RRC IE which is configured by the RCE.

In certain representative embodiments, segmentation procedures may be employed. Different modeling possibilities may be employed for segmentation. For example, segmentation may be applied to MAC CE, e.g., if it takes up the whole MAC PDU, or MAC CE segments may be created with a secondary node (SN), e.g., when utilizing multiplexing.

The information contained in the RCE may be larger than the number of information bits available in a transport block. The WTRU may segment the RCE in the uplink or re-assemble segments of the RCE in the downlink using at least one of the following solutions.

In certain representative embodiments, segmentation of the RCE may be applied only under a condition that no other information than the RCE to be segmented is already multiplexed in the TB. Whether the condition is applicable or not may depend on the RCE type or RCE priority level.

In certain representative embodiments, segmentation information related to a (first) RCE may be included in MAC subPDU, MAC CE, or (second) RCE. The segmentation information may include at least one of an identity of the first RCE, the size of the whole RCE, the number of segments, or the size(s) of each segment, and the like. The MAC subPDU, MAC CE or second RCE may be multiplexed in every MAC PDU containing a segment of the first RCE. In such case, it may contain additional information applicable to the segment such as a segment index, the position of the segment within the whole RCE in units of X bits or bytes (e.g., segmentation offset), whether the segment is a first, middle or last segment, and the like.

In certain representative embodiments, segmentation information related to the RCE may be included in a MAC header/subheader applicable to each RCE or segment of the RCE. For example, a MAC header/subheader can indicate at least one of the following information: whether the corresponding MAC PDU/subPDU is a full RCE or RCE segment, an identity of the RCE, a segment number, a segmentation offset, a length of the RCE or RCE segment, whether the segment is a first, a middle or a last segment, and the like. Alternatively, the information may be included in a header within the RCE. The segmentation information may be included if more than one RCE segment is generated. The identity of the RCE may correspond, for example, to a sequence number, such that the identity of a new RCE is incremented from the identity of the previously transmitted RCE.

In one example, downlink control information (DCI) for a grant or assignment may indicate segmentation information related to the RCE included in the transport block, such as a segment index and a total number of segments.

In one example, segmentation information may include a priority level. The receiving entity may use priority level during re-assembly operation as described below.

A segment number may be represented by a field with a fixed number of bits. Alternatively, the segment number may be encoded by a sequence of K bits of a first value (e.g. zero (0)) followed by 1 bit of a second value (e.g. one (1)), where the value of K corresponds to the segment number.

For downlink operation, the WTRU may de-multiplex subPDUs (e.g., MAC subPDUs) corresponding to segments of RCE and store the RCE segments in a reception segmentation entity. Upon determining that all segments of the RCE are received, the WTRU may re-assemble the RCE, flush the segmentation entity and process the RCE information. The WTRU may initiate transmission of an indication that the RCE was successfully received. The indication may be included in the RCE or a MAC CE.

The WTRU may store first and second RCE segments in first and second segmentation entities if it determines that first and second segments correspond to different RCE's. The WTRU may determine this using the RCE identity indicated for each RCE segment.

The WTRU may maintain up to a maximum number M of segmentation entities, where M may be pre-defined, may be a WTRU capability, or may be configured by higher layers. If the WTRU has at least one RCE segment stored for each of M segmentation entities, and receives the RCE segment with the RCE identity that does not correspond to the RCE identity of any segment stored in a segmentation entity, the WTRU may perform at least one of the following actions: select one segmentation entity among the M entities; flush the selected segmentation entity; or initiate transmission of an indication that the RCE was not successfully received. Regarding selecting one segmentation entity among the M entities, the WTRU may use at least one of the following criteria for the selection: entity for which the latest received segment was received at the earliest time among segmentation entities; entity with the smallest number of stored segments or the smallest amount of data in stored segments; entity for which RCE identity is the smallest; or entity containing RCE segments with lowest priority level. Regarding initiating transmission of an indication that the RCE was not successfully received, this may be under a condition that the priority level is above a certain pre-defined or configured threshold; the indication may be included in the RCE or a MAC CE; and/or the indication may include at least the RCE identity. In some examples, the above actions may be performed only if the received RCE segment is for the RCE that has equal or higher priority than the priority of at least one RCE for which at least one segment is stored in the segmentation entity.

In a solution, the WTRU may receive an indication to flush at least one segmentation entity for RCEs. Such indication may be useful if the transmitting entity (e.g. network) has RCE of higher priority to send. The flush indication may be received as a MAC CE, the RCE, or from a field of DCI. The WTRU may flush all segmentation entities upon reception of the flush indication. Alternatively, the WTRU may flush a subset of segmentation entities based on indication of applicable RCE identity(ies) or maximum priority level.

For uplink operation, the WTRU may be configured to segment the RCE if the TB size is insufficient for the transmission of the whole RCE. The WTRU may store the RCE in a transmission segmentation entity. The WTRU may first transmit a MAC CE or another RCE indicating the size of the RCE to be segmented. The WTRU may flush the segmentation entity for the RCE if it receives an indication that the RCE was successfully received, or if it receives indication to flush the segmentation entity for the indicated RCE. Such indication may be received by MAC CE or RCE.

The WTRU may store first and second RCE that are available for transmission in first and second segmentation entities. If the number of RCE's or amount of data stored in segmentation entities would exceed a maximum, the WTRU may flush at least one segmentation entity. Possible criteria for selecting the segmentation entity to be flushed may be the same as for re-assembly operation. The WTRU may initiate transmission of an indication that the RCE was not successfully transmitted, e.g., under a condition that the priority level is above a certain pre-defined or configured threshold. The indication may be included in the RCE or a MAC CE.

In certain representative embodiments, regarding header design, a direct LCID to RCE (e.g., MAC RCE) mapping is defined where each LCID points to a specific RCE (e.g., MAC RCE). It should be noted that LCID (like in NR) is used only as naming convention here and the field with indices mapping to MAC RCEs could be named differently. The mapping between an LCID and RCE (e.g., MAC RCE) may be pre-defined in the specification or provided in a RRC configuration message by the NW (e.g., similar to RRC Setup, RRC Resume, RRC Reestablishment, RRC Reconfiguration, etc.). To allow future extensibility, RCEs (e.g., MAC RCEs) may be generally defined as flexible sized and an L (Length) field may be provided in the subheader (e.g., MAC subheader). In some examples, fixed sized RCE (e.g., MAC RCE) may be exploited where no future extensions are to be applied.

In certain representative embodiments, one or more LCID index values are allocated to point to a specific feature/layer/action configuration and a further LCIDe extension field follows in the MAC subheader (e.g., further byte in the MAC subheader is encoded in this case) which specifies the specific MAC RCE signaled in the MAC PDU. This may facilitate the number of LCID index values employed to point to specific RCE(s) and the further LCIDe extension field may be used for this purpose. The mapping between LCID index values and the specific feature/layer/action configuration and mapping between an LCIDe extension index and MAC RCE may be pre-defined in the specification or provided in a RRC configuration message by the NW (e.g., similar to RRC Setup, RRC Resume, RRC Reestablishment, RRC Reconfiguration, etc.).

In certain representative embodiments, if the grant provides only MAC RCE(s), a subheader (e.g., MAC subheader) may not be utilized (e.g., in case only one MAC RCE is allowed to be provided in a MAC PDU). This may also be indicated in the DCI or implicitly deduced based on the DCI by the WTRU that there is one MAC RCE in the MAC PDU.

In certain representative embodiments, the WTRU may generate an uplink confirmation RCE (e.g., MAC CE), alternatively named an uplink RCE or a WTRU state RCE (e.g., MAC CE), for the following purposes or if at least one or more of the following conditions/scenarios is satisfied or met. For example, the WTRU may reply with a new confirmation UL RCE (e.g., MAC CE) upon reception of a downlink RCE (e.g., MAC RCE). Such confirmation MAC CE may be beneficial to ensure that the WTRU is in synch with the NW and has received/applied the signaled configuration change. If the WTRU is not to synch when the control change is applicable in time (in terms of timing), there can be some error conditions. The RCE (e.g., radio control MAC CE) may provide a configuration/confirmation ID which is replicated by the WTRU in the confirmation RCE (e.g., MAC CE) to ensure multiple configurations can be run in parallel. In an option, each RCE (e.g., radio control MAC CE) is provided a separate confirmation RCE (e.g., MAC CE) or multiple RCEs (e.g., radio control MAC CEs) may be confirmed by a single confirmation RCE (e.g., MAC CE).

As another example, the WTRU may generate an uplink confirmation RCE based on reception of a trigger/indication from higher layers (e.g. RRC) to transmit control information over a data layer, data link layer, or intermediate layer (e.g. MAC), e.g. contents of existing RRC messages (RRC (re)-establishment, RRC resume, etc.) or upper layer control information that is triggered by RRC procedures. The WTRU may reply with a WTRU state in response to an inquiry from the network (e.g. in a DL MAC CE) about the WTRU's processing state, power saving state, CPU load, and/or WTRU over-heating state, and the like.

As another example, the WTRU may generate an uplink confirmation RCE upon a dynamic change of a WTRU capability/support of a feature or feature combination, and/or upon successful completion of a procedure or reconfiguration indicated by the DL MAC RCE.

As another example, the WTRU may trigger the uplink confirmation RCE (e.g., confirmation MAC CE) upon receiving a segment of the RCE. For example, the confirmation RCE (e.g., confirmation MAC CE) may include the segment information it is confirming. Alternatively, the WTRU triggers the confirmation RCE (e.g., confirmation MAC CE) upon fully receiving the RCE.

In one example, WTRU initiates a timer upon transmission of the confirmation RCE (e.g., confirmation MAC CE) where the timer is stopped upon receiving UL grant for new transmission on the same HARQ process used to transmit the confirmation RCE (e.g., confirmation MAC CE); where the timer is restarted upon transmitting a new confirmation RCE (e.g., confirmation MAC CE), e.g., for another segment of the RCE); and/or upon expiry of the timer, the confirmation RCE (e.g., confirmation MAC CE)is triggered to be transmitted again.

The WTRU may receive a grant for the transmission of the UL confirmation MAC CE described in the above. The grant may be indicated in RCE (e.g., MAC CE or MAC RCE) included in the same transport block as the RCE (e.g., MAC CE or MAC RCE) for which confirmation is to be provided.

If the WTRU has no available grant for the transmission of the RCE (e.g., MAC CE or MAC RCE) containing acknowledgment information, the WTRU may initiate a scheduling request procedure where the pending scheduling request is cancelled when a PDU (e.g., a MAC PDU) containing such RCE (e.g., MAC CE or MAC RCE) is transmitted.

The WTRU may be configured to provide physical layer acknowledgment of PDSCH (HARQ-ACK) wherein CRC is appended to HARQ-ACK information regardless of the HARQ-ACK payload, such that probability of NACK to ACK misinterpretation is minimized. The WTRU may perform this operation for a HARQ-ACK codebook containing HARQ-ACK information of at least one PDSCH for which an indication to append CRC is received. The indication may be received from DCI or higher layers.

An identifier such as, for example, a transaction identifier, may be indicated in association with the RCE (e.g., a MAC RCE), either as part of its payload or of a header/sub-header. The WTRU may include the identifier in an uplink confirmation RCE (e.g., MAC CE). If the WTRU receives first and second RCEs (e.g., MAC RCEs) with same transaction identifier, the WTRU may apply a corresponding procedure only once. This may be under a condition that a minimum period has elapsed between receptions of first and second MAC RCE.

In certain representative embodiments, regarding UL RCE (e.g., MAC RCE) transmission procedures, a UL grant may be reserved for the transmission of a MAC CE, of the RCE, or segment thereof. Whether the grant is restricted to transmission of the RCE only may be indicated by a field of DCI, a radio network temporary identifier (RNTI), implicitly by a property of the PDCCH (e.g. coreset, search space), a DCI size in the case of a dynamic grant, or by higher layer configuration for a configured grant. The grant may further restrict MAC CE, RCE's (or segment thereof) depending on the following aspects: whether it is a complete RCE or a segment of the RCE; whether the RCE is a confirmation RCE (or confirmation MAC CE); the type of contents of the RCE; and/or the priority level of the RCE. A DCI for the grant may further indicate segmentation information related to the RCE included in the transport block, such as, for example, a segment index and a total number of segments.

In certain representative embodiments, the WTRU may include indication that a physical uplink shared channel (PUSCH) carries a TB in which the RCE is multiplexed. Such indication may be encoded as uplink control information (UCI) multiplexed in the PUSCH. The information may be beneficial for the network to determine a maximum number of HARQ retransmissions.

A WTRU may be configured to retransmit or be ready to retransmit RCE (e.g., a MAC RCE) under certain conditions. This functionality may be enabled for certain types of RCEs (e.g., a MAC RCEs) only and for certain priority level(s). A retransmitted RCE (e.g., a retransmitted MAC RCE) may be associated with a different sequence number or different RCE identity than the original RCE (e.g., the original MAC RCE). A retransmitted RCE (e.g., a retransmitted MAC RCE) may share a same identifier (such as transaction identifier or the like) as an original RCE (e.g., an original MAC RCE).

If retransmission is configured for a RCE (e.g., a MAC RCE), the WTRU may keep the information of the MAC RCE in a retransmission entity. The WTRU may flush a retransmission entity when at least one of the following conditions occurs. For example, the WTRU may flush a retransmission entity when the WTRU receives an indication to flush the retransmission entity or an indication that the RCE (e.g., a MAC RCE)was successfully received. The indication may be, for example, from a MAC CE, a MAC RCE, or DCI. The indication may include an identity associated to the MAC RCE.

As another example, may flush a retransmission entity when the time the RCE was stored in the retransmission entity was more than a maximum period. The period may be pre-defined or configured by higher layers. The period may depend on the type of RCE or the priority level of the RCE.

As another example, may flush a retransmission entity when a new RCE becomes available for transmission and the number of RCE's or the amount of data stored in retransmission entities would exceed a maximum number R of retransmission entities, where R may be predefined, may be a WTRU capability or may be configured by higher layers. The WTRU may select a retransmission entity to flush based on at least one of the following criteria: entity for which the RCE was stored at the earliest time among retransmission entities; entity for which RCE identity is the smallest; entity for which RCE has lowest priority level; entity for which the number of (re-transmissions already performed is the highest.

The WTRU may then initiate transmission of an indication that the RCE was not successfully transmitted. This may be under a condition that the priority level is above a certain pre-defined or configured threshold. The indication may be included in the RCE, a MAC CE or as uplink control information. The indication may include at least a transaction identifier associated with the RCE.

The WTRU may initiate a transmission or retransmission of the RCE stored in a retransmission entity when at least one of the following occurs: the WTRU receives an indication to perform retransmission of the RCE, where such indication may be from a MAC CE or RCE, and such indication may include the RCE identity or a transaction identifier associated with the RCE; the number of HARQ transmissions for a TB containing the RCE or a segment of the RCE has reached a maximum value, where the maximum value may be pre-defined or configured, and the maximum value may depend on a type or a priority level of the RCE.

When the WTRU retransmits the RCE, the WTRU may perform following actions: if segmentation is supported, flush the corresponding segmentation entity; increment a sequence number of RCE identity for the retransmitted RCE, but use the same value for a transaction identifier; if segmentation needs to be performed, store the RCE in a segmentation entity; and/or multiplex the RCE in a PDU (e.g., a MAC PDU).

In certain representative embodiments, the WTRU may assign a priority of RCE and/or confirmation MAC CE for the purpose of at least logical channel prioritization against other user plane data, higher-layer (e.g. SRB) control data and other MAC CE's. The priority of RCE may depend on the type of control information carried by the RCE. For example, the RCE carrying reconfiguration information may be assigned to be the same or higher than the priority of MAC SDU containing SRB information.

The WTRU may assign priority of a confirmation RCE (e.g., confirmation MAC CE) based on the priority associated to the corresponding RCE, e.g. assign the same priority level. The WTRU may assign a higher priority to the RCE and/or corresponding confirmation RCE (e.g., confirmation MAC CE) if a higher-layer (e.g. RRC) procedure is pending completion of the MAC procedure.

The relative priority between the RCE and/or corresponding confirmation RCE (e.g., confirmation MAC CE) on one hand, and of an SDU (e.g., a MAC SDU) containing SRB information on the other hand, may depend on the RRC procedure supported by the SRB information. For example, an SDU (e.g., a MAC SDU) carrying information for a measurement report procedure may have higher priority than the RCE or its corresponding confirmation RCE (e.g., confirmation MAC CE).

The relative priority between the RCE and/or corresponding confirmation RCE (e.g., confirmation MAC CE) on one hand, and of another type of RCE (e.g., MAC CE) on the other hand, may depend on the type of information carried by the RCE (e.g., MAC CE). For example, a MAC CE carrying HARQ-ACK information may have higher priority than the RCE or its corresponding confirmation MAC CE.

The priority of RCE carrying control information that may also be provided by RRC signaling (such as, for example, information elements for reconfiguration) may be the same as the priority of MAC SDU that includes this RRC signaling (SRB). In case an RRC procedure and a MAC procedure are concurrently running and affecting or potentially affecting the same configuration information, the WTRU may prioritize completion of either the MAC or the RRC procedure. Such prioritization may be pre-defined or configured.

The format of an UL RCE can be similar to a DL RCE. The WTRU may assume that UL RCEs preside within a self-decodable and/or separate part of a transport block. Such spare part can be a separately decodable TB portion within the TB, where such parts are encoded/decoded separately (e.g. may have separate CRCs and/or MAC headers). The WTRU may leave some lower priority UL RCEs for construction after grant reception (e.g. after T2), and include them only if they fit in the grant (e.g. once all data and other control/MAC CEs of higher priority have been included). The priority of an UL RCE can be determined from a predefined prioritization list (which prioritizes data and other control elements) or can be configured.

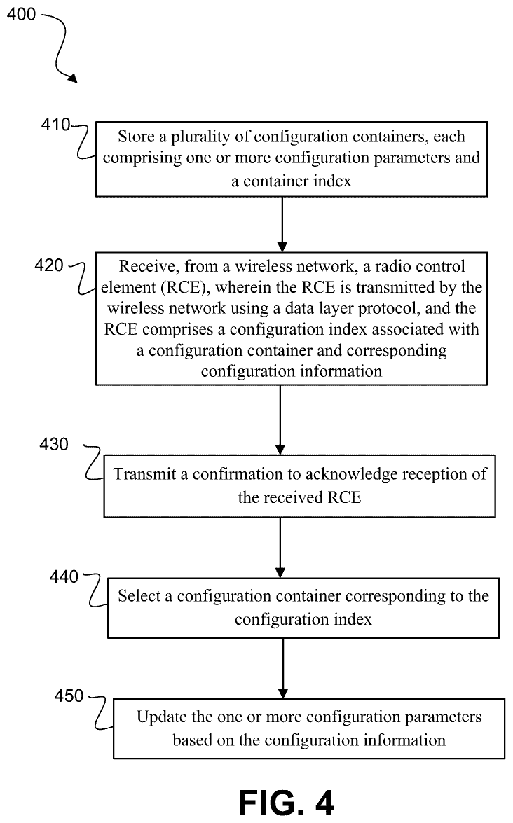

FIG. 4 is a procedural diagram illustrating an example procedure, performed by a WTRU, in accordance with certain embodiments of the present disclosure.

In certain representative embodiments, processes of FIG. 4 may be performed by a WTRU (e.g., WTRU 102, 210, or the like) in communication with a wireless network (e.g., RAN 104/113, or the like). The WTRU may comprise a processor (e.g., processor 118); computer memory (e.g., non-removable memory 130 and/or removable memory 132) coupled to the processor; and a transceiver (e.g., transceiver 120) coupled to the processor.

At step 410, the WTRU may store (e.g., in the computer memory of the WTRU) a plurality of configuration containers, each comprising one or more configuration parameters and a container index. In some embodiments, the plurality of configuration containers may be stored in the form of a tree structure 300 comprising a plurality of nodes, as shown in FIG. 3. In some embodiments, the plurality of configuration containers are received from a wireless network (e.g., wireless network 220), at any suitable time, transmitted using any suitable technique.

In some embodiments, the one or more configuration parameters comprises at least one of cell beam parameters, a number of antenna elements and associated configuration parameters, physical layer transmission parameters, or configuration parameters for data flow. In some embodiments, the one or more configuration parameters comprises at least one of priority, minimum or guaranteed bit rates, MAC configuration parameters, PDCP parameters, or RLC configuration parameters.

At step 420, the WTRU may receive, from a wireless network, the RCE. The RCE may be transmitted by the wireless network using a data layer protocol. The RCE may comprise a configuration index associated with a configuration container and corresponding configuration information. In some embodiments, the data layer protocol used to transmit the RCE corresponds to an L2 MAC protocol. In some embodiments, step 420 corresponds to step 1 of FIG. 2.

In some embodiments, the RCE comprises segmentation information indicating at least one of an identity of a first RCE segment of a plurality of RCE segments of the RCE, a total size of the plurality of RCE segments, a number of the plurality of RCE segments, or sizes of the plurality of RCE segments.

In some embodiments, the WTRU determines the configuration index of the RCE from an indication part of a TB subheader or a value tag within a payload of the RCE.

At step 430, the WTRU may transmit a confirmation to acknowledge reception of the received RCE. For example, the confirmation may be transmitted to the wireless network (e.g., RAN 104/113). In some embodiments, step 430 corresponds to step 2 of FIG. 2.

At step 440, the WTRU may select a configuration container corresponding to the configuration index. In some embodiments, the configuration container may be selected from among the plurality of configuration containers stored at the WTRU. In some embodiments, selecting the configuration container comprises selecting the node, e.g., in tree structure 300 shown in FIG. 3, corresponding to the configuration container and one or more lower hierarchy nodes that depend from the selected node.

At 450, the WTRU may update the one or more configuration parameters (e.g., of at least one of the stored plurality of configuration containers) based on the configuration information (e.g., indicated in the received RCE). In some embodiments, step 440 may correspond to step 4 of FIG. 2.

In some embodiments, the updated one or more configuration parameters are used to configure the WTRU for a limited period of time, and the limited period time is specified by at least one of the RCE or by a higher layer signaling protocol in relation to the intermediate layer protocol.

In some embodiments, such as, for example, when the plurality of configuration containers are stored in the form of tree structure 300 of FIG. 3, the WTRU may, at 450, update the one or more configuration parameters based on the configuration information by updating the one or more configuration parameters for the configuration container corresponding to the selected node and the one or more configuration parameters for one or more configuration containers corresponding to the one or more lower hierarchy nodes, discussed above in relation to step 440.

In some embodiments, an acknowledgement is received from the wireless network, where such acknowledgment corresponds to successful reception of the confirmation, and the updating of the one or more configuration parameters performed at 450 is performed after receiving the acknowledgement.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method implemented by a wireless transmit/receive unit (WTRU), the method comprising:
storing a plurality of configuration containers, each comprising one or more configuration parameters and a container index;
receiving, from a wireless network, a radio control element (RCE), wherein the RCE:
is transmitted by the wireless network using a data layer protocol; and
comprises a configuration index associated with a configuration container and corresponding configuration information;
transmitting a confirmation to acknowledge reception of the received RCE;
selecting a configuration container corresponding to the configuration index; and
updating the one or more configuration parameters based on the configuration information.

2. The method of claim 1, wherein the data layer protocol corresponds to a layer 2 media access control (MAC) protocol.

3. The method of claim 1, further comprising determining the configuration index from an indication part of a transport block subheader or a value tag within a payload of the data.

4. The method of claim 1, wherein the one or more configuration parameters comprises at least one of cell beam parameters, a number of antenna elements and associated configuration parameters, physical layer transmission parameters, or configuration parameters for data flow.

5. The method of claim 1, wherein the one or more configuration parameters comprises at least one of priority, minimum or guaranteed bit rates, media access control (MAC) configuration parameters, packet data convergence protocol (PDCP) parameters, or radio link control (RLC) configuration parameters.

6. The method of claim 1, wherein:
the updated one or more configuration parameters are used to configure the WTRU for a limited period of time; and
the limited period time is specified by at least one of the RCE or by a higher layer signaling protocol in relation to the intermediate layer protocol.

7. The method of claim 1, wherein:
storing a plurality of configuration containers further comprises storing the plurality of configuration containers in the form of a tree structure comprising a plurality of nodes; and
selecting the configuration container comprises selecting the node corresponding to the configuration container and one or more lower hierarchy nodes that depend from the selected node.

8. The method of claim 7, wherein:
updating the one or more configuration parameters based on the configuration information comprises updating the one or more configuration parameters for the configuration container corresponding to the selected node and the one or more configuration parameters for one or more configuration containers corresponding to the one or more lower hierarchy nodes.

9. The method of claim 1, wherein the RCE comprises segmentation information indicating at least one of an identity of a first RCE segment of a plurality of RCE segments of the RCE, a total size of the plurality of RCE segments, a number of the plurality of RCE segments, or sizes of the plurality of RCE segments.

10. The method of claim 1, further comprising:
receiving, from the wireless network, an acknowledgement corresponding to successful reception of the confirmation, wherein updating the one or more configuration parameters is performed after receiving the acknowledgement.

11. A wireless transmit/receive unit (WTRU) in communication with a wireless network, the WTRU comprising:
a processor; and
a transceiver coupled to the processor, wherein the WTRU is configured to:
store a plurality of configuration containers, each comprising one or more configuration parameters and a container index;
receive, from a wireless network, radio control element (RCE), wherein the RCE:
is transmitted by the wireless network using a data layer protocol; and
comprises a configuration index associated with a configuration container and corresponding configuration information;
transmit a confirmation to acknowledge reception of the received RCE;
select a configuration container corresponding to the configuration index; and
update the one or more configuration parameters based on the configuration information.

12. The WTRU of claim 11, wherein the data layer protocol corresponds to a layer 2 media access control (MAC) protocol.

13. The WTRU of claim 11, wherein the WTRU is configured to determine the configuration index from an indication part of a transport block subheader or a value tag within a payload of the RCE.

14. The WTRU of claim 11, wherein the one or more configuration parameters comprises at least one of cell beam parameters, a number of antenna elements and associated configuration parameters, physical layer transmission parameters, or configuration parameters for data flow.

15. The WTRU of claim 11, wherein the one or more configuration parameters comprises at least one of priority, minimum or guaranteed bit rates, media access control (MAC) configuration parameters, packet data convergence protocol (PDCP) parameters, or radio link control (RLC) configuration parameters.

16. The WTRU of claim 11, wherein:
the WTRU is configured to use the updated one or more configuration parameters to configure the WTRU for a limited period of time; and
the limited period time is specified by at least one of the RCE or by a higher layer signaling protocol in relation to the intermediate layer protocol.

17. The WTRU of claim 11, wherein the WTRU is configured to:
store a plurality of configuration containers by storing the plurality of configuration containers in the form of a tree structure comprising a plurality of nodes; and
select the configuration container by selecting the node corresponding to the configuration container and one or more lower hierarchy nodes that depend from the selected node.

18. The WTRU of claim 17, wherein the WTRU is configured to:
update the one or more configuration parameters based on the configuration information by updating the one or more configuration parameters for the configuration container corresponding to the selected node and the one or more configuration parameters for one or more configuration containers corresponding to the one or more lower hierarchy nodes.

19. The WTRU of claim 11, wherein the RCE comprises segmentation information indicating at least one of an identity of a first RCE segment of a plurality of RCE segments of the RCE, a total size of the plurality of RCE segments, a number of the plurality of RCE segments, or sizes of the plurality of RCE segments.

20. The WTRU of claim 11, wherein the WTRU is configured to:
receive, from the wireless network, an acknowledgement corresponding to successful reception of the confirmation; and
perform the updating of the one or more configuration parameters after receiving the acknowledgement.
